(19) United States
(12) Patent Application Publication
(10) Pub. No.: US 2009/0288120 A1
(43) Pub. Date: Nov. 19, 2009

(54) System and Method for Creating Media Bookmarks from Secondary Device

(75) Inventors: Venugopal Vasudevan, Palatine, IL (US); Tzvetan T. Horozov, Hoffman Estates, IL (US); Andrew J. Aftelak, Palatine, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/121,416

(22) Filed: May 15, 2008

(51) Int. Cl. H04N 5/445

(52) U.S. Cl. 725/58

(57) ABSTRACT

There is disclosed a mobile device, and a method thereof, for creating media bookmarks. The mobile device comprises a user interface, a timing circuit, a processor, and a wireless transceiver. The user interface detects first and second user inputs associated with a media clip, in which the first user input precedes the second user input. The timing circuit provides a time stamp at a given time. The processor determines an end time associated with the media clip corresponding to a time stamp when the first user input is detected, and a start time associated with a media clip based on the second user input. The processor also identifies a broadcast channel associated with the media clip. The wireless transceiver transmits clip information based on the start and end times to a remote server via a wireless communication link.

### FIELD OF THE INVENTION

The present invention relates generally to the field of media control devices capable of creating, editing or otherwise controlling video content. The present invention specifically relates to a system having a primary device for displaying media content and a secondary device for creating media bookmarks of the media content displayed by the primary device.

### BACKGROUND OF THE INVENTION

Video sharing services designate a location, such as a website, for uploading, viewing and otherwise sharing multimedia clips of media content. The media content for these video sharing services may include user-generated content, such as video blogging and user-originated video, or commercially-generated, such as music videos, movie clips, television clips. Social networking by users of video sharing services has resulted in users creating and uploading bookmarks from broadcast content. These bookmarks are short video clips, usually part of a longer piece such as a full broadcast program, that are selections of various broadcasts having a limited duration and, typically, consist of a select portion of a particular multimedia broadcast. Sources for bookmarks include news and sporting events, historical videos, music videos, television programs, film trailers, and vlogs. Bookmarks also distinguish from full broadcast programs in that Bookmarks are available on-demand, whereas the broadcast programs from which they may be based are not necessarily available on-demand.

There are two popular methods for creating the bookmarks of broadcast content. For one method, a user may capture broadcast content at a computer via a media interface having tuning circuitry, use video editing software to select a clip of interest of the broadcast content, and then manually upload the clip to a web site of a video sharing service. For another method, a user may have a client device connect to a broadcast receiver, such as a television, and the client device may be equipped with the functionality to pause/play/rewind broadcast content on the broadcast receiver. The user may select the start and end time of the clip of interest of the broadcast content and post the clip to at a server of a video sharing service. Unfortunately, neither of these methods have tapped the full potential for market acceptance of bookmark creation due to certain inconveniences. The first method is not very user friendly and can not be adopted by a large population of users. The second method is easier to use but requires a specialized client device which, again, reduces the targeted population reach for the service. Current methods, therefore, do not provide adequate solution to allow and promote users to create bookmarks from broadcast content.

There is a need for a system for providing users with a convenient method for creating media bookmarks when a user discovers broadcast content of potential interest. The method should provide the convenience of substantially immediate response, via a simple activation and programming process. The method should also provide the convenience of creating the media bookmarks on a device readily available to each user. A readily available device may not always be associated with the broadcast device viewed by the user, so the method should further provide a process for quickly identifying the content viewed by the user for purposes of creating the media bookmark.

### BRIEF DESCRIPTION OF THE DRAWINGS

FIG. 1 is a block diagram of an embodiment of the system for creating media bookmarks in accordance with the present invention.

FIG. 2 is a block diagram of an embodiment of the mobile device of the system of FIG. 1.

FIG. 3 is a flow diagram illustrating of a first method for creating media bookmarks in accordance with the present invention.

FIG. 4 is a flow diagram illustrating of a second method for creating media bookmarks in accordance with the present invention.

FIG. 5 is a flow diagram illustrating of a third method for creating media bookmarks in accordance with the present invention.

### DETAILED DESCRIPTION OF THE EMBODIMENTS

There is disclosed a device and method for creating media bookmarks when a user discovers broadcast content of potential interest.

One aspect of the present invention is a method of a mobile device for creating media bookmarks, the mobile device including a user interface capable of receiving user input. A first user input is detected at the user interface associated with a media clip. An end time associated with the media clip denoting a time stamp when the first user input is detected is determined. A broadcast channel associated with the media clip is identified. A second user input is detected at the user interface associated with the media clip. A start time associated with a media clip based on the second user input is determined. Clip information based on the start time and the end time is transmitted to a remote server.

Another aspect of the present invention is a mobile device for creating media bookmarks comprising a user interface, a timing circuit, a processor coupled to the timing circuit, and a wireless transceiver. The user interface detects first and second user inputs associated with a media clip, in which the first user input precedes the second user input. The timing circuit provides a time stamp at a given time. The processor determines an end time associated with the media clip corresponding to a time stamp when the first user input is detected, and a start time associated with a media clip based on the second user input. The processor also identifies a broadcast channel associated with the media clip. The wireless transceiver transmits clip information based on the start and end times to a remote server via a wireless communication link.

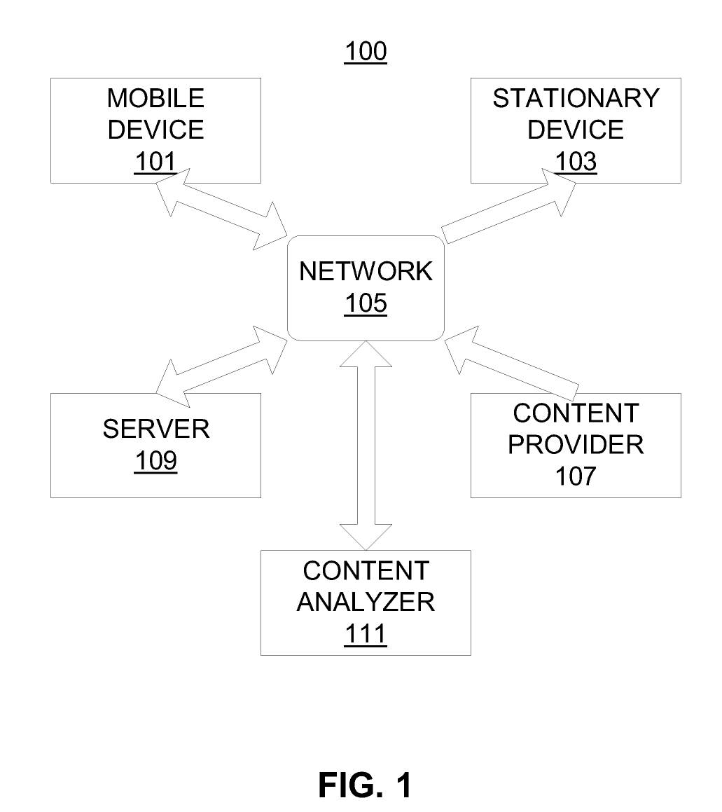

Referring to FIG. 1, there is shown a block diagram of an embodiment of the system 100 for creating media bookmarks in accordance with the present invention. The system comprises a secondary 101, a primary device 103, a network 105 and a content provider 107, and a server 109. The primary device 103 of FIG. 1 is an example of a primary device that provides media content, and the mobile device 101 of FIG. 1 is an example of a secondary device within a vicinity of the primary device. The secondary device 101 may identify a media clip of the broadcast content that is to be bookmarked. A mobile device is typically “mobile”, or portable, so it is generally battery-powered and/or capable of wireless communication. Examples of secondary or mobile devices include, but not limited to, cellular phones, peer-to-peer communication devices, portable computing devices, other wireless remotes and communicators, and accessories for the same. The primary device 103 is one or more broadcast receivers, such as a video monitor (such as a television), a set top box or a combination thereof. It is important to note that, for the present invention, there is a physical separation between the media content presenting device, i.e., the primary or station device 103, and the device controlling the function of bookmarking the media content, i.e., the secondary or mobile device 101.

The secondary device 101 and the primary device 103 may user different technologies for communication information. The primary device 103 may broadcasts media signals to various destinations simultaneously via a first communication means, whereas the secondary device 101 may transmit a clip of the media signals via a second communication means different from the first communication means. The secondary device 101 may utilize wireless technology for communication, such as, but are not limited to, cellular-based communications, and next generation communications and their variants; a peer-to-peer or ad hoc communications; and other forms of wireless communication. Although the primary device 103 may receive media content using similar technology, broadcast information for communicating television content utilizes standard broadcasting technologies such as NTSC (National Television System Committee), PAL (Phase Alternating Line), SECAM (Sequential Color With Memory), QAM (Quadrature Amplitude Modulation), ATSC (Advanced Television Systems Committee), DVB (Digital Video Broadcasting), ISDB (Integrated Services Digital Broadcasting), DMB (Digital Multimedia Broadcasting).

Since the secondary device may be a mobile device, such as mobile device 101, it is often carried by its user and, thus, remains conveniently available. Also, the secondary device 101 provides the convenience of substantially immediate response, via a simple activation and programming process, by utilizing a time stamp to reference an end time for the media clip and providing one or more pre-selected start times or durations for user selection. In addition, the secondary device 101 may not always be associated with, i.e., may not have discovered or recognized, the primary device viewed by the user, so the secondary device may also provide a process for quickly identifying the content viewed by the user for purposes of creating the multimedia bookmark.

The content provider 107 provides the media content to the primary device 103 via the network 105, and the secondary device 101 communicates with the remote server 109 via the network 105. The content provider 107 also provides the media content to the remote server 109, so that the server has access to the same media content that is available to the mobile device 101. Examples of media content includes audio content, motion video content, still image content, and any combination of these different types of content (i.e., multimedia content). It is to be understood that the network 105 is only a general representation of communications among devices and, thus, may include multiple communication means and/or multiple networks. In fact, the network 105 may include multiple, distinct networks that have no connection with one another and/or no common communication means.

The clip information, which identifies the portion of the broadcast content to be clipped or bookmarked, is delivered from the secondary device 101 to the remote server 109 via the network 105, so that the remote server can create a bookmark of the media content. The server 109 may be an individual server or a federation of servers, in which each server is assigned to a particular geographic region based on the media content available throughout the geographic regions. For a federation of servers, a dispatching mechanism may be used to direct each secondary device 101 to a particular regional server based on the location of the secondary device.

For one embodiment, while a user is viewing a television program, the user can activate a button on a mobile device and invoke a client application. The client application may be a local (such as MIDlet) or accessible via a network (such as Web-based). At that time, the client application on the device connects to a remote service provider, such as server 109, and retrieves channel information of an electronic programming guide that is available to the mobile device 101, and thus its user. The mobile device 101 can then select a channel using the client application that corresponds to the channel that the user of the mobile device is currently watching on his or her television. For the purpose of this embodiment, the time at which the user selects the channel at the secondary device indicates the time within the media content at which the user decides to end the bookmarked clip.

When a channel selection is made, the client application contacts the service provider at the server 109 and provides information regarding the channel selection that the user has made. Based on that information, the server 109 identifies the media content that the user is watching and the content frame at which the user has made the selection. This is possible due to the fact that the media content available at the primary device 103 of the user and the media content available at the server 109 are the same. That selection is used by the server 109 to locate the media content and prepare a response back to the client application. The response contains content timing information of the media content available to the user over a period of time with respect to the content time made by the user in the channel selection step described previously. The content timing information may be presented in various ways, such as a start time relative to the time stamp of the first user input, or a duration relative to the time stamp of the first user input. For example, the client application may retrieve indicators of the content for the current time, such as 30 seconds from the time stamp of the first user input, 60 seconds from the time stamp of the first user input, 90 second from the time stamp of the first user input, etc. By viewing the indicators, the mobile device 101 can select the desired media clip and send that information to the service at server 109 using the client application. The service at server 109 may be a “tuner farm” that includes a broadcast tuner for every channel available to the primary device 103. The service at server 109 may then uses the clip information to create a bookmark of the media content and post the bookmark on a designated location, such as a web site of the World Wide Web.

The process of selecting a media clip may be enhanced by providing detail which, in turn, may facilitate a user's selection of the desired clip properties. For example, the client application may receive from the server 109 thumbnail snapshot, i.e., still images, of the media content available to the user over a period of time. The client application may retrieve snapshots of the media content for the current time, 30 seconds from the time stamp of the first user input, 60 seconds from the time stamp of the first user input, etc. Each snapshot may represent a particular view each media clip which represents the corresponding media clip, but distinguishes it from other snapshots. For one embodiment, the snapshot may be the first frame of a media clip which corresponds to the start time of the media clip. By viewing the thumbnails, the user of the secondary device 101 may select the desired media clip with more ease.

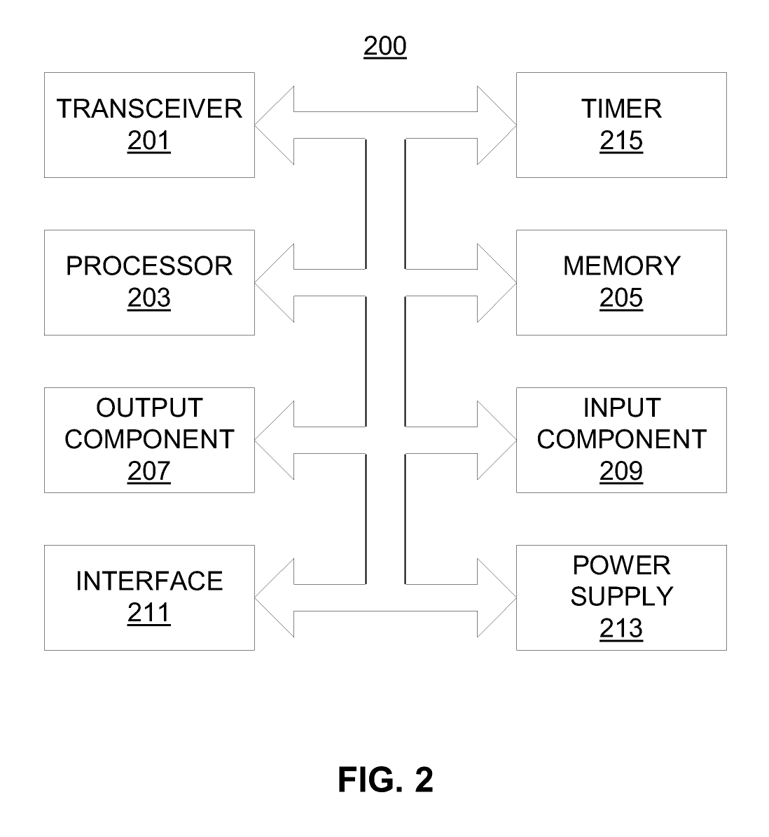

Referring to FIG. 2, there is provided a block diagram illustrating exemplary internal components 200 of the secondary or mobile device in accordance with the present invention. The exemplary embodiment includes one or more wired or wireless transceivers 201, a processor 203, a memory portion 205, one or more output components 207, and one or more input components 209. Each embodiment may include a user interface that comprises one or more output components 207 and one or more input component 209. Each transceiver 201 may be directly wired to another component or utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE or IEEE 802.16) and their variants; a peer-to-peer or ad hoc communications such as HomeRF, Bluetooth and IEEE 802.11(a, b, g or n); and other forms of wireless communication such as infrared technology. Each transceiver 201 may be a receiver, a transmitter or both. For example, for one embodiment of the secondary or mobile device, the transceiver may transmit clip information based on the start and end times to the remote server 109, and receive an acknowledgment from the remote server indicating that a media bookmark based on the clip information has been created. For another embodiment, the transceiver 201 may include a second transceiver that discovers a broadcast receiver, such as stationary device 103, within a vicinity of the secondary or mobile device, so that the processor 203 may identify the broadcast channel that is presented by the broadcast receiver.

The processor 203 may generate commands based on information received from one or more input components 209 or by processing the received information in combination with other data, such as the information stored in the memory portion 205. For example, the transceiver 201 may retrieve information about one or more broadcast channels from the server 109 via a wireless communication link, and provide the retrieved information to the processor 203. Also, the processor 203 may obtain a list of broadcast channels based on a subscription associated with the secondary or mobile device and identify a particular broadcast channel of the list of broadcast channels based on a user input at the user interface.

The processor 203 may obtain a list of broadcast channels in a variety of ways. For example, the processor 203 may generate the list of broadcast channels based on a user profile and/or a location of the secondary or mobile device. Also, the processor 203 may receive the list of broadcast channels via the transceiver 201 from a remote device, such as the server 109.

The input components 209 of the internal components 200 may include a video input component such as an optical sensor (for example, a camera), an audio input component such as a microphone, and a mechanical input component such as button or key selection sensors, touch pad sensor, touch screen sensor, capacitive sensor, motion sensor, and switch. For example, the input components 209 may include an audio sensor for monitoring audio information in a vicinity of the secondary or mobile device in response to detecting a user input at the user interface and, in response, the processor 203 may identify the broadcast channel based on the audio information. Likewise, the output components 207 of the internal components 200 may include a variety of video, audio and/or mechanical outputs. For example, the output components 207 may include a video output component 316 such as a cathode ray tube, liquid crystal display, plasma display, incandescent light, fluorescent light, front or rear projection display, and light emitting diode indicator. For example, the output components 209 may include a display that presents duration information, start information, and/or static images for each content clip. Other examples of output components 207 include an audio output component such as a speaker, alarm and/or buzzer, and/or a mechanical output component such as vibrating or motion-based mechanisms.

The memory portion 205 of the internal components 200 may be used by the processor 203 to store and retrieve data. The data that may be stored by the memory portion 205 include, but is not limited to, operating systems, applications, and data. Each operating system includes executable code that controls basic functions of the secondary or mobile device, such as interaction among the components of the internal components 200, communication with external devices via each transceiver 201 and/or the component interface (see below), and storage and retrieval of applications and data to and from the memory portion 205. Each application includes executable code utilizes an operating system to provide more specific functionality for the secondary or mobile device. Data is non-executable code or information that may be referenced and/or manipulated by an operating system or application for performing functions of the secondary or mobile device. For example, the processor 203 may retrieve information about a broadcast channel from the memory portion 205.

The internal components 200 may further include a component interface 211 to provide a direct connection to auxiliary components or accessories for additional or enhanced functionality. Auxiliary components or accessories that may communicate with the transceiver 201 and/or component interface 211 include one or more sensors for detecting light, sound, odor, motion, connectivity and power to produce the remote and local state data. The internal components 200 preferably include a power source 213, such as a power supply or portable battery, for providing power to the other internal components. The internal components 200 still further include a timing circuit to provide a time stamp at a given time, which will be explained in detail below.

It is to be understood that FIG. 2 is provided for illustrative purposes only and for illustrating components of a secondary or mobile device in accordance with the present invention, and is not intended to be a complete schematic diagram of the various components required for a secondary or mobile device. Therefore, a secondary or mobile device may include various other components not shown in FIG. 2, or may include a combination of two or more components or a division of a particular component into two or more separate components, and still be within the scope of the present invention.

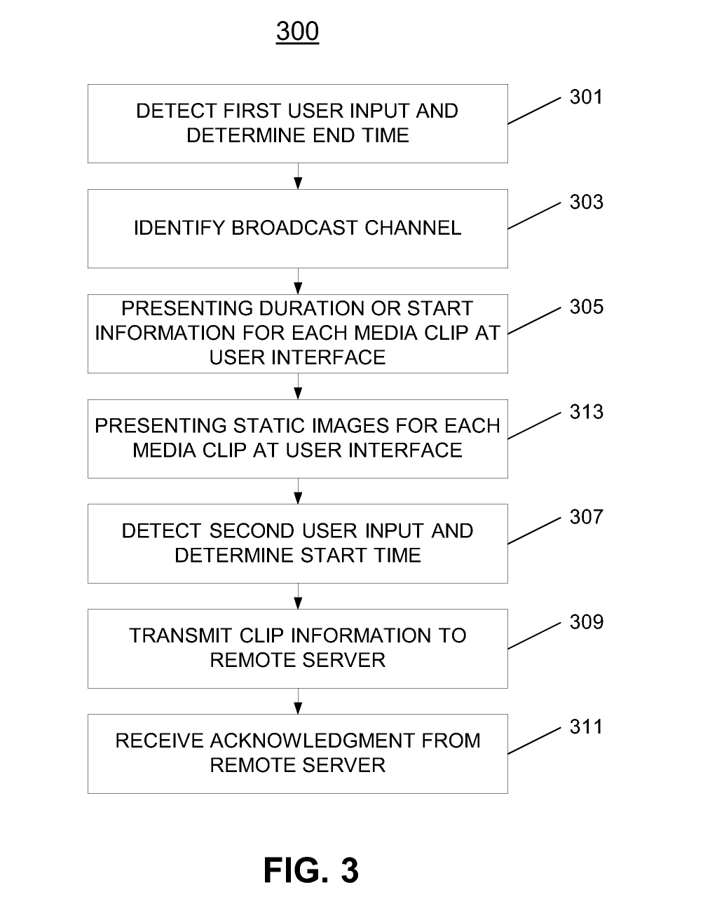

Referring to FIG. 3, there is provided a flow diagram illustrating of a first method 300 for creating media bookmarks in accordance with the present invention. A user interface of the input components 209 of the secondary device 101 detects a first user input associated with a media clip at step 301. For example, the first user input may be a key selection a keypad or activation of a client application. For one embodiment, the first user input may be detected at the user interface in response to a user of the secondary device 101 watching media content of the primary device 103, such as a television or similar video output device. The processor 203 of the secondary device 101 determines an end time associated with the media clip denoting a time stamp of when the first user input is detected at step 301. When the first user input is detected, the processor 203 receives a current time stamp from the timing circuit 215, which corresponds to the end time of the media clip.

The secondary device 101 then identifies a broadcast channel associated with the media clip at step 303. For one embodiment, the processor 203 retrieves information about a predetermined broadcast channel associated the secondary device from the memory portion 205 from a remote device via the transceiver 201. For another embodiment, the processor 203 obtains a list of broadcast channels based on a subscription associated with the secondary device from the memory portion 205 from a remote device via the transceiver 201. For this embodiment, the user interface of the input components 209 detect a third user input associated with the media clip, and the processor 203 identifies a particular broadcast channel of the list of broadcast channels based on the third user input. The list of broadcast channels may be obtained in a variety of ways. For example, the processor 203 may generate the list of broadcast channels based on a user profile and/or a location of the secondary device. Also, the processor 203 may receive the list of broadcast channels via the transceiver 201 from a remote device, such as the server 109.

At step 305, a display of the output components 207 of the secondary device 101 may present two or more options for selecting the start time or duration of the media clip. The duration or start information for each media clip is presented at the user interface.

Next, the user interface of the input components 209 of the secondary device 101 detects a second user input associated with a media clip at step 307. The processor 203 of the secondary device 101 then determines a start time associated with the media clip based on the second user input at step 307. The transceiver 201 of the secondary device 101 transmits clip information to a remote server 109 at step 309. The clip information is based on the start and end times associated with the media clip, so the clip information may include the actually start and end times or may include data that has been processed based on the start and end times. Thereafter, the transceiver 201 receives an acknowledgment from the remote server 109 indicating that a media bookmark based on the clip information has been created at step 311.

It should be noted that in addition to, or in the alternative to, the duration or start information presented at step 305, the display of the output components 207 may present a static image for each content clip before detecting the second user input. The static image may be retrieved from the memory portion 205 of the secondary device 101 or received from a remote device via the transceiver 201.

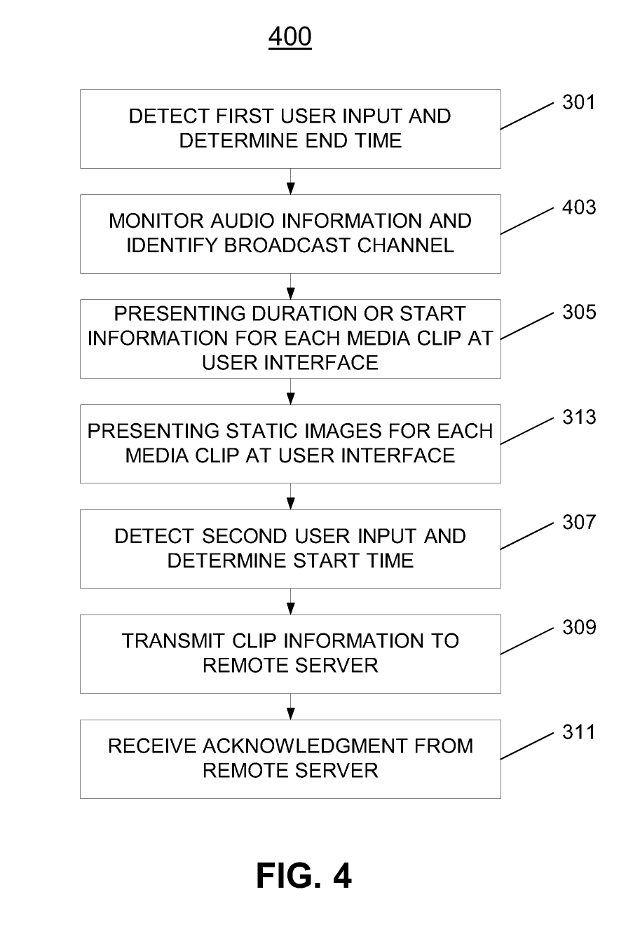

Referring to FIG. 4, there is provided a flow diagram illustrating of a second method 400 for creating media bookmarks in accordance with the present invention. This second method 400 is similar to the first method 300 shown in FIG. 3, but additionally includes a step of analyzing the media content provided by the primary device 103 at the secondary device 101 in order to identify the broadcast channel of the media content. In particular, the secondary device 101 monitors and captures audio information in the vicinity of the secondary device in response to detecting the first user input at the user interface, as represented by step 403. The audio information captured by the secondary device includes an audio portion of the media content as audibly emitted by the primary device 103. The secondary device 101 includes audio input sensor of the input components 209, such as a microphone, to collect the audio information. In addition, the processor 203 of the secondary device 101 receives the audio information from the input component 209 and identifies the broadcast channel of the media content based on the audio information, as represented by step 403.

Referring back to FIG. 1, the system 100 may further comprise a content analyzer 111 that is capable of performing a detection search of media content based on audio information received from the primary device 103. The content analyzer 111 may communicate with the secondary device 101 and the server 109 via the network 105. In the alternative, the content analyzer 111, or its functionality, may be integrated in the secondary device 101 or the server 109. The content analyzer 111 detects the broadcast channel and media content presented within a vicinity of the secondary device 101, and thus likely to be observed by the user of the secondary device, and delivers the detected information, or a processed form thereof, to the server 109.

The second method 400 is not restricted to monitoring live media content. The second method 400 also has applicability to time-shifted media content and any other type of media content that provides an audio portion, such as pre-recorded media content (such as DVD content). The second method 400 may also allow deeper semantic analysis of the media content to enhance the precision in identifying the start time and the end time of media clips that represent the natural segmentation within the media content, such as identification of scored goals, scored touchdowns, delivery of jokes, etc.

For the embodiments described above, there is no need to apply special modifications to the existing broadcast devices, such as television or set top boxes, as the secondary device and the broadcast device are not directly associated. Accordingly, the system described above is readily available to a large population of users and their legacy broadcast devices.

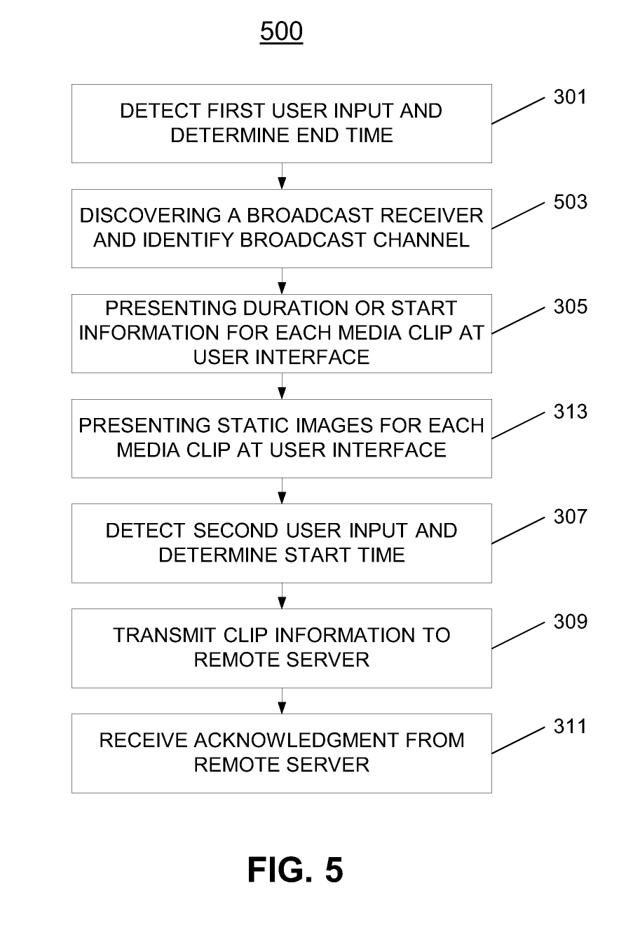

Referring to FIG. 5, there is provided a flow diagram illustrating of a third method 500 for creating media bookmarks in accordance with the present invention. This third method 500 is similar to the first method 300 shown in FIG. 3, but additionally includes a step of discovering a broadband receiver associated with the media content, such as the primary device 103, at the secondary device 101, and a further step of identifying the broadcast channel of the media content that is presented by the broadcast receiver, as represented by step 503. Various types of communication protocols may be utilized by the secondary device 101 in discover the primary or station device 103, such as the cellular-based communications, next generation communications and their variants, peer-to-peer or ad hoc communications, and other forms of wireless communication described above with regard to the communications of the secondary device with server 109 via the network 105. Also, communications may occur between the secondary device 101 and one or more primary devices, such as a set top box and/or video monitor. This embodiment allows the primary device 103 to communicate minimal information to the secondary device 101, and such information may include the television content identification, channel identification, etc., coupled with protocol information exchange.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims. For example, although some of the above embodiments provide examples based on multimedia content, such as television broadcasts, it is to be understood that the present invention is not restricted to multimedia content, and may also apply to other types of media content, such as audio content, multi-audio content or video-without-audio content.

What is claimed is:

1. A method of a mobile device for creating media bookmarks, the mobile device including a user interface capable of receiving user input, the method comprising:
detecting a first user input at the user interface associated with a media clip;
determining an end time associated with the media clip denoting a time stamp when the first user input is detected;
identifying a broadcast channel associated with the media clip;
detecting a second user input at the user interface associated with the media clip;
determining a start time associated with a media clip based on the second user input; and
transmitting clip information based on the start and end times to a remote server.

2. The method of claim 1, wherein detecting a first user input at the user interface includes detecting an activation of a client application.

3. The method of claim 1, wherein identifying a broadcast channel includes retrieving information about a predetermined broadcast channel associated the mobile device.

4. The method of claim 1, wherein identifying a broadcast channel comprises:
obtaining a list of broadcast channels based on a subscription associated with the mobile device;
detecting a third user input at the user interface associated with the media clip; and
identify a particular broadcast channel of the list of broadcast channels based on the third user input.

5. The method of claim 4, wherein obtaining a list of broadcast channels includes at least one of generating the list of broadcast channels based on a user profile, generating the list of broadcast channels based on a location of the mobile device, or receiving the list of broadcast channels from a remote device.

6. The method of claim 1, wherein:
identifying a broadcast channel includes identifying a channel that broadcasts media signals to a plurality of destinations simultaneously via a first communication means; and
transmitting clip information includes transmitting the clip information via a second communication means different from the first communication means.

7. The method of claim 1, further comprising receiving a plurality of duration or start information for the content clip and presenting the duration or start information at the mobile device before detecting the second user input.

8. The method of claim 1, further comprising receiving a plurality of static image for the content clip and presenting each static image at the mobile device before detecting the second user input.

9. The method of claim 1, further comprising receiving an acknowledgment from the remote server indicating that a media bookmark based on the clip information has been created.

10. The method of claim 1, further comprising:
monitoring audio information in a vicinity of the mobile device in response to detecting a first user input at the user interface,
wherein identifying a broadcast channel includes identifying the broadcast channel based on the audio information.

11. The method of claim 1, further comprising:
discovering a broadcast receiver within a vicinity of the mobile device; and
identifying the broadcast channel that is presented by the broadcast receiver.

12. A mobile device for creating media bookmarks comprising:
a user interface configured to detect first and second user inputs associated with a media clip, the first user input preceding the second user input;
a timing circuit configured to provide a time stamp at a given time;
a processor coupled to the timing circuit, the processor configured to determine an end time associated with the media clip corresponding to a time stamp when the first user input is detected, identify a broadcast channel associated with the media clip, and determine a start time associated with a media clip based on the second user input; and
a wireless transceiver configured to transmit clip information based on the start and end times to a remote server via a wireless communication link.

13. The mobile device of claim 12, further comprising a memory, wherein the processor retrieves information about the broadcast channel from the memory.

14. The mobile device of claim 12, wherein the transceiver retrieves information about the broadcast channel from the remote server via the wireless communication link, and provide the retrieved information to the processor.

15. The mobile device of claim 12, wherein:
the user interface detects a third user input associated with the media clip; and
the processor obtains a list of broadcast channels based on a subscription associated with the mobile device and identifies a particular broadcast channel of the list of broadcast channels based on the third user input.

16. The mobile device of claim 15, wherein the processor obtains a list of broadcast channels by at least one of generating the list of broadcast channels based on a user profile, generating the list of broadcast channels based on a location of the mobile device, or receiving the list of broadcast channels from a remote device.

17. The mobile device of claim 12, wherein the broadcast channel is associated with a channel that broadcasts media signals to a plurality of destinations simultaneously via a communication means, the communication means being different from the wireless communication link.

18. The mobile device of claim 12, further comprising a display configured to present a plurality of duration or start information for the content clip at the mobile device.

19. The mobile device of claim 12, further comprising a display configured to present a plurality of static images for the content clip at the mobile device.

20. The mobile device of claim 12, wherein the transceiver receives an acknowledgment from the remote server indicating that a media bookmark based on the clip information has been created.

21. The mobile device of claim 12, further comprising:
an input component configured to monitor audio information in a vicinity of the mobile device in response to detecting a first user input at the user interface,
wherein the processor identifies the broadcast channel based on the audio information.

22. The mobile device of claim 12, further comprising:
a second transceiver discovers a broadcast receiver within a vicinity of the mobile device,
wherein the processor identifies the broadcast channel that is presented by the broadcast receiver.
